(19) United States
(12) Patent Application Publication
(10) Pub. No.: US 2011/0255847 A1
(43) Pub. Date: Oct. 20, 2011

(54) RAPID HEAT TREATMENT APPARATUS THAT ENABLES EXTENDED PYROMETER LIFE

(75) Inventor: Sang Hyun Ji, Gyeonggi-do (KR)

(73) Assignee: ASIA PACIFIC SYSTEMS, INC, GYEONGGI-DO (KR)

(21) Appl. No.: 13/132,682

(22) PCT Filed: Nov. 27, 2009
(86) PCT No.: PCT/KR09/07054

§ 371 Date: Jul. 11, 2011

(30) Foreign Application Priority Data
Dec. 5, 2008 (KR) 10-2008-0122937

(51) Int. Cl. F27D 11/12

(52) U.S. Cl. 392/407

(57) ABSTRACT

In the rapid heat treatment apparatus according to the present invention, the pyrometer comprises a light receiving rod that is used to receive radiated light emitted from a wafer; a light source that is installed to radiate light onto a wafer through the light receiving load; and a light sensing part that receives radiated light reflected after being radiated from the light source to the wafer and light emitted from the wafer to measure the temperature of the wafer, wherein a transparent protective cap is installed on the light receiving load so that the light receiving load is not contaminated by by-products formed after the wafer is heated. According to the present invention, contamination is prevented by the transparent protective cap so that any difficulty experienced from replacing an expensive light receiving rod is eliminated, and the need for initial setting of the pyrometer is also eliminated, so that process downtime is reduced and process efficiency is enhanced.

### TECHNICAL FIELD

The present invention relates to a rapid thermal process (RTP) apparatus and, more particularly, to an RTP apparatus in which a transparent protective cap is installed to a pyrometer so as to prevent the pyrometer from being contaminated by by-products produced from a wafer during an RTP cycle, and which detects the contamination and informs a user of the contamination so as to allow the user to replace the contaminated protective cap, if the transparent protective cap is excessively contaminated.

### BACKGROUND ART

Generally, during a rapid thermal process (RTP) of a wafer, by-products are produced from the wafer and tend to adhere to a process chamber when the RTP cycle is terminated and the temperature of the process chamber is lowered. While the temperature of the wafer is generally measured by a pyrometer, if the inside of the process chamber is contaminated, the pyrometer can also be contaminated, causing inaccurate detection of the temperature of the wafer.

FIG. 1 is a schematic view of a conventional RTP apparatus. In FIG. 1, when an RTP cycle is performed on a wafer 20 by a heat lamp 60 with the wafer mounted in an edge ring 30 in a process chamber 10, the temperature of the wafer is measured by a pyrometer 40 and the temperature detected by the pyrometer 40 is fed back to a power supply of the heat lamp 60 through a temperature controller 50 to carry out temperature control.

During the RTP, by-products are produced from the wafer 20 and are adhered to a wall of the process chamber 10 when the RTP is terminated and the temperature is lowered. Here, the by-products also adhere to light-receiving rods 41 of the pyrometer, so that when the temperature of the wafer 20 is detected by the pyrometer 40 through the light-receiving rods 41, the detected temperature is different from an actual temperature of the wafer.

To solve this problem, according to the related art, replacement of the light-receiving rods 41 or preventive maintenance (PM) is periodically performed before severe contamination due to the by-products. Thus, there are cases in which expensive light-receiving rods 41 are replaced even when serious contamination are not occurred, thereby increasing maintenance costs of equipment. Further, a PM cycle is shortened, thereby deteriorating productivity. Further, when the light-receiving rods 41 are replaced, the setting condition of the pyrometer 40 must be initialized, making it very troublesome to replace the light-receiving rods 41.

### DISCLOSURE

### Technical Problem

An aspect of the present invention provides a rapid thermal process apparatus capable of extending the lifetime of a pyrometer and a PM cycle for the pyrometer.

### Technical Solution

In accordance with an aspect of the invention, a rapid thermal process (RTP) apparatus includes: a heat lamp heating a wafer; a pyrometer measuring a temperature of the wafer, the pyrometer including a light-receiving rod receiving radiant light emitted from the wafer, a light source irradiating the wafer through the light-receiving rod, and a photo-detector measuring the temperature of the wafer by receiving light reflected from the wafer after the light is irradiated to the wafer from the light source and radiant light emitted from the wafer through the light-receiving rod; and a temperature controller controlling output power of the heat lamp to control the temperature of the wafer in response to a return signal based on a temperature measured by the pyrometer, wherein a transparent protective cap is provided to cover the light-receiving rod to prevent the light-receiving rod from being contaminated by heated by-products from the wafer.

The transparent protective cap may be formed of quartz.

The temperature controller may receive, from a user, a reference error range that defines an error limit with respect to a reference emissivity detected by the photo-detector when the transparent protective cap is not contaminated, and if the emissivity detected by the photo-detector is determined to be within the reference error range, perform temperature correction based on the determination result and allow the RTP to proceed, and if the emissivity detected by the photo-detector is determined to be out of the reference error range, generate an alarm signal.

### ADVANTAGEOUS EFFECTS

According to embodiments of the invention, since contamination of the light-receiving rod 141 can be prevented by the transparent protective cap 170, there is no need to frequently replace the light-receiving rod 141 so long as only the transparent protective cap 170 is replaced in time. Further, the setting of the pyrometer 140 is not required to be initialized, so that process interruption time is reduced and process efficiency is thus improved. Furthermore, the expensive light-receiving rod 141 is not frequently replaced, thereby lowering maintenance costs.

### DESCRIPTION OF DRAWINGS

FIG. 1 is a schematic view of a conventional rapid thermal process apparatus;

FIGS. 2 and 3 are schematic views of a rapid thermal process apparatus according to an exemplary embodiment of the present invention;

FIG. 4 is a view explaining the principle of measuring temperature of a pyrometer 140;

FIGS. 5 and 6 are graphs depicting a temperature difference according to the degree of contamination of a transparent protective cap 170; and

FIG. 7 is a flowchart of a method for determining whether to replace the protective cap 170.

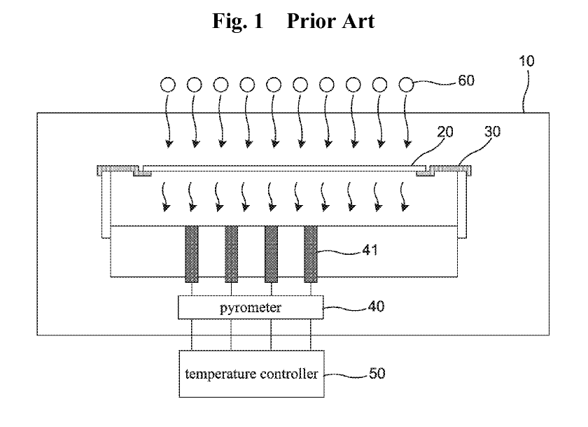

### MODE FOR INVENTION

Exemplary embodiments of the invention will be described in detail. However, it will be apparent to those skilled in the art that the invention is not limited to the embodiments herein and can be implemented in various ways.

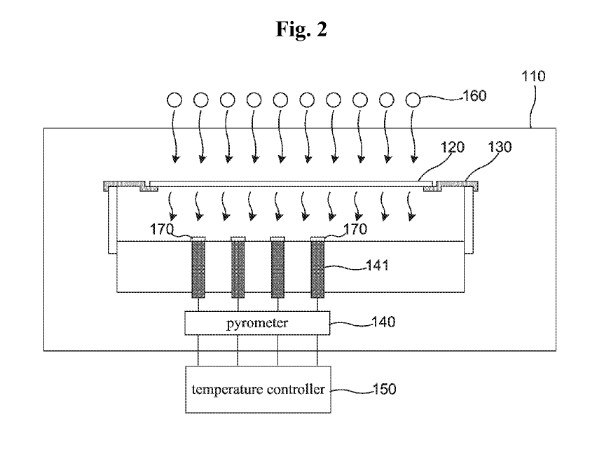

FIG. 2 is a schematic view of a rapid thermal process (RTP) apparatus according to an exemplary embodiment of the invention. In FIG. 2, an RTP cycle is performed on a wafer 120 by a heat lamp 160 with the wafer mounted in an edge ring 130 in a process chamber 110, and a transparent protective cap 170 formed of quartz is mounted on a light-receiving rod 141 of a pyrometer 140 for measuring the temperature of the wafer 120 to prevent the light-receiving rod 141 from being contaminated.

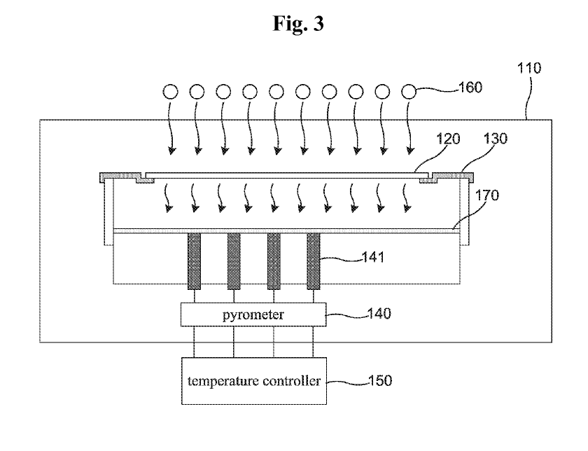

Although the transparent protective cap 170 can have a stopple shape that is only mounted on the light-receiving rod 141 as shown in FIG. 2, it may also be formed like a plate that is placed on an upper portion of the light-receiving rod so as to divide a space into a light-receiving rod 141 part and a wafer 120 part, as shown in FIG. 3.

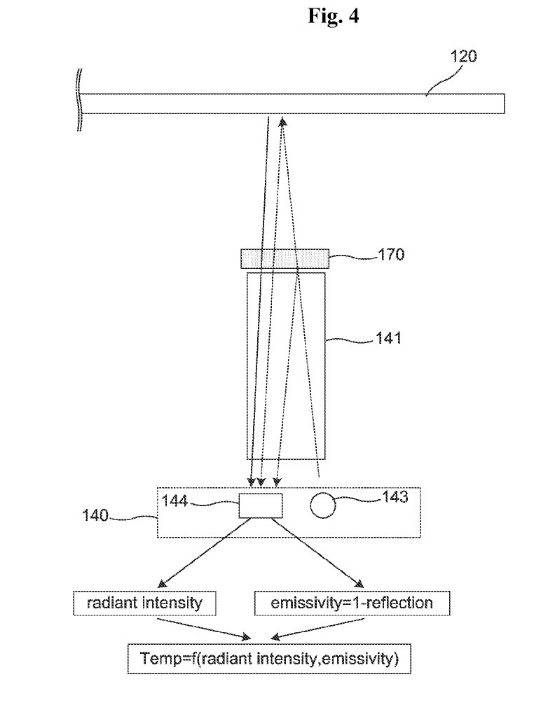

FIG. 4 is a view explaining the principle of measuring the temperature by the pyrometer 140. As shown in FIG. 4, the pyrometer 140 includes a light source 143 and a photo-detector 144. The photo-detector 144 receives radiant light emitted from the wafer 120 and light reflected from the wafer 120 to measure the temperature of the wafer 120 based on radiant intensity and emissivity of the light.

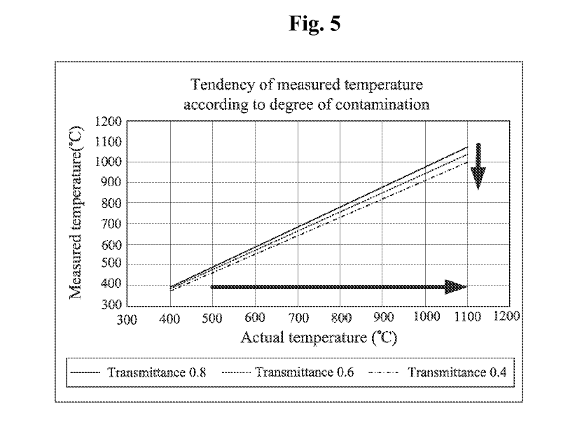

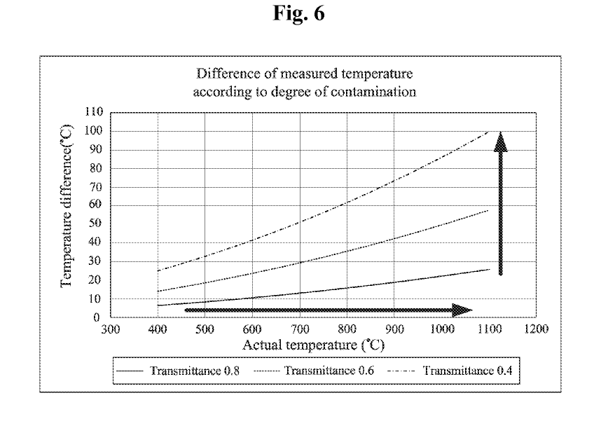

Since the light-receiving rod 141 of the pyrometer 140 is covered with the transparent protective cap 170, there is a difference between the temperature measured by the pyrometer 140 and an actual temperature of the wafer 120, as the transparent protective cap 170 becomes contaminated. That is, as can be seen from the graph of FIG. 5, as the transparent protective cap 170 becomes contaminated, the temperature measured by the pyrometer 140 becomes lower than the actual temperature of the wafer 120, and such a tendency is further intensified with increasing temperature. Thus, as shown in the graph of FIG. 6, as the transparent protective cap 170 becomes contaminated, the degree of difference between the temperature measured by the pyrometer 140 and the actual temperature of the wafer 120 increases, and such a difference increases with increasing temperature. The degree of contamination of the transparent protective cap 170 is indicated by transmittance, and lower transmittance means heavier contamination.

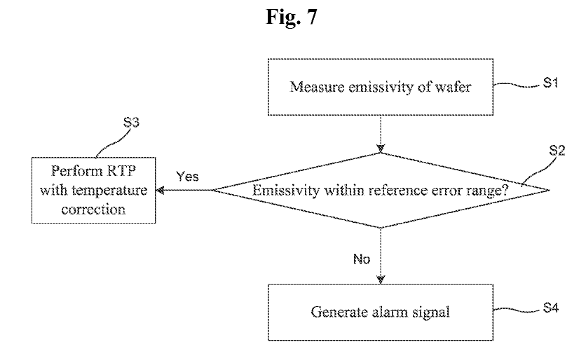

FIG. 7 is a flowchart of a method for determining whether to replace the protective cap 170. As described above, as the transparent protective cap 170 becomes contaminated, the emissivity detected by the pyrometer 140 decreases.

The temperature controller 150 controls power of the heat lamp 160 based on emissivity (hereinafter, “reference emissivity”) input to the pyrometer through the protective cap 170 when the protective cap is not contaminated.

When the emissivity of the wafer 120 is measured by the pyrometer 140, the degree of contamination of the transparent protective cap 170 can be determined (S1). This is because the emissivity measured by the pyrometer 140 falls below the reference emissivity as the transparent protective cap 170 becomes contaminated.

A reference error range that defines an error limit with respect to the reference emissivity is input to the temperature controller 150 by a user. The temperature controller 150 determines whether the emissivity measured by the pyrometer 140 is within the reference error range (S2). If the emissivity is within the reference error range, the temperature controller performs temperature correction based on the determination result and allows the RTP cycle to proceed (S3), and if the emissivity is out of the reference error range, the temperature controller determines that the protective cap 170 is heavily contaminated and generates an alarm signal to allow a user to replace the protective cap (S4).

1. A rapid thermal process (RTP) apparatus comprising:
a heat lamp heating a wafer;
a pyrometer measuring a temperature of the wafer, the pyrometer including a light-receiving rod receiving radiant light emitted from the wafer, a light source irradiating the wafer through the light-receiving rod, and a photo-detector measuring the temperature of the wafer by receiving light reflected from the wafer after the light is irradiated to the wafer from the light source and radiant light emitted from the wafer through the light-receiving rod; and
a temperature controller controlling output power of the heat lamp to control the temperature of the wafer in response to a return signal based on a temperature measured by the pyrometer,
wherein a transparent protective cap is provided to cover the light-receiving rod to prevent the light-receiving rod from being contaminated by heated by-products from the wafer.

2. The RTP apparatus of claim 1, wherein the transparent protective cap is formed of quartz.

3. The RTP apparatus of claim 1, wherein the temperature controller receives, from a user, a reference error range that defines an error limit with respect to a reference emissivity detected by the photo-detector when the transparent protective cap is not contaminated, and if the emissivity detected by the photo-detector is determined to be within the reference error range, performs temperature correction based on the determination result and allows the RTP to proceed, and if the emissivity detected by the photo-detector is determined to be out of the reference error range, generates an alarm signal.
